(19) United States
(12) Patent Application Publication
(10) Pub. No.: US 2025/0013073 A1
(43) Pub. Date: Jan. 9, 2025

(54) EYEGLASSES FRAME AND NOSE PAD ASSEMBLY

(71) Applicant: Arthur WANG, Taipei City (TW)

(72) Inventor: Arthur WANG, Taipei City (TW)

(21) Appl. No.: 18/347,646

(22) Filed: Jul. 6, 2023

(51) Int. Cl. G02C 5/12; G02C 1/06

(52) U.S. Cl. CPC G02C 5/126; G02C 1/06; G02C 2200/08

(57) ABSTRACT

An eyeglasses frame and nose pad assembly has an eyeglasses frame and two nose pads. The eyeglasses frame has two rims having a combining portion. The combining portion has a main body and two recesses. The main body has a first primary engaging portion and a second primary engaging portion. The two nose pads are detachably mounted on the two combining portions respectively. Each of the nose pads is flexible and has an abutting portion and two protrusions. The abutting portion has a second secondary engaging portion, and the two protrusions have a first secondary engaging portion. The nose pad is mounted on the combining portion via multiple engaging structures, the main body extending on the abutting portion, and the recess engaging with the protrusion, increasing comfort of wearing the eyeglasses frame and nose pad assembly, slip-resistance, support performance, and a lifespan of the eyeglasses frame and nose pad assembly.

### BACKGROUND OF THE INVENTION

### 1. Field of the Invention

The present invention relates to an eyeglasses frame and nose pad assembly, especially to an eyeglasses frame and nose pad assembly with detachable nose pads.

### 2. Description of the Prior Arts

Eyeglasses are common for those who need vision correction or styling, and they usually need to wear eyeglasses for a long time in daily lives. Thus, to improve comfort and to extend lifespan are important goals for improving eyeglasses. In fact, contact between an eyeglasses frame and nose pad assembly and a nose of a user is a major factor that would significantly affect comfort of wearing.

Conventionally, there are two ways to support the eyeglasses frame and nose pad assembly on the nose of the user: one is mounting two pad arms to two adjacent sides of two rims respectively, and then setting each one of two nose pads at a distal end of a respective one of the two pad arms; the other way is, instead of mounting the pad arms, forming two wing portions on the two adjacent sides of the two rims respectively, and the two wing portions would contact the nose of the user to support the eyeglasses frame and nose pad assembly; in other words, the nose pads are integrated into the rims respectively. However, some disadvantages exist in the aforementioned two types of the eyeglasses frame and nose pad assembly.

First, the pad arms are prone to deformation or breakage by collision, thereby reducing the comfort and the lifespan of the eyeglasses frame and nose pad assembly; in addition, a cost of manufacturing said eyeglasses frame and nose pad assembly increases due to more components and complex assembling procedures.

Secondary, the eyeglasses frame and nose pad assembly with integrated nose pads and eyeglasses frame directly contacts the nose of the user, such that the user may feel a little uncomfortable and the eyeglasses frame and nose pad assembly may easily slip on a face of the user.

To overcome the shortcomings, the present invention provides an eyeglasses frame and nose pad assembly to mitigate or obviate the aforementioned problems.

### SUMMARY OF THE INVENTION

The main objective of the present invention is to provide an eyeglasses frame and nose pad assembly that is capable of increasing comfort of wearing, and slip-resistance, support performance, and a lifespan of the eyeglasses frame and nose pad assembly via rims and nose pads which are capable of engaging with each other.

The eyeglasses frame and nose pad assembly has an eyeglasses frame and two nose pads. The eyeglasses frame has two rims and two combining portions. Each one of the two combining portions is formed on a lateral part of a respective one of the two rims, and the two lateral parts of the two rims are oriented toward each other; each one of the two combining portions includes at least one recess and a main body. The main body has a first primary engaging portion and a second primary engaging portion. The first primary engaging portion is formed on a side, which is oriented toward the at least one recess, of the main body, and the second primary engaging portion is formed on an inner lateral surface of the main body which faces to a nose of a user. The first primary engaging portion and the second primary engaging portion are formed in different directions.

The two nose pads are detachably mounted on the two combining portions respectively, and each one of the two nose pads is flexible and has at least one protrusion, a first secondary engaging portion, an abutting portion, and a second secondary engaging portion. The at least one protrusion engages with the at least one recess of a corresponding one of the two combining portions. The first secondary engaging portion is formed on the at least one protrusion and detachably engages with the first primary engaging portion of the main body of the corresponding combining portion. The abutting portion is connected to the at least one protrusion. The second secondary engaging portion is formed on the abutting portion and detachably engages with the second primary engaging portion of the main body of the corresponding combining portion. The first secondary engaging portion and the second secondary engaging portion are formed in different directions.

The advantages of the eyeglasses frame and nose pad assembly are as follows:

(1) By omitting conventional pad arms, a connection between the nose pads and the eyeglasses frame gets a better strength to resist collision, thereby preventing the eyeglasses frame and nose pad assembly from deformation and breaking, and further reducing a manufacturing cost.

(2) Through the two nose pads which are flexible and mounted on the two combining portions respectively, not only comfort of wearing the eyeglasses frame and nose pad assembly but also slip-resistance and the support performance increase.

(3) The nose pads are mounted on the combining portions via engaging along varied directions, and stability of combining is enhanced via the main bodies abutting on the abutting portions and the recesses engaging with the protrusions to prevent the nose pads from detaching.

(4) Due to mounting the nose pads on the combining portions via engaging, mounting the nose pads on the combining portions is convenient. Therefore, an efficiency of manufacturing the eyeglasses frame and nose pad assembly increases, and the user is easy to combine or detach the nose pads for cleaning.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of an eyeglasses frame and nose pad assembly in accordance with the present invention;

FIG. 2 is an exploded partial-enlarged perspective view of the eyeglasses frame and nose pad assembly in FIG. 1;

FIG. 3 is a partial-enlarged perspective view of the eyeglasses frame and nose pad assembly in FIG. 1, showing nose pads transparent;

FIG. 4 is an exploded partial-enlarged perspective view of a second embodiment of the eyeglasses frame and nose pad assembly in accordance with the present invention;

FIG. 5 is a partial-enlarged perspective view of the eyeglasses frame and nose pad assembly in FIG. 4, showing nose pads transparent;

FIG. 6 is an exploded partial-enlarged perspective view of a third embodiment of the eyeglasses frame and nose pad assembly in accordance with the present invention;

FIG. 7 is a partial-enlarged perspective view of the eyeglasses frame and nose pad assembly in FIG. 6, showing nose pads transparent;

FIG. 8 is an exploded partial-enlarged perspective view of a fourth embodiment of the eyeglasses frame and nose pad assembly in accordance with the present invention; and

FIG. 9 is a partial-enlarged perspective view of the eyeglasses frame and nose pad assembly in FIG. 8, showing nose pads transparent.

### DETAILED DESCRIPTION OF THE PREFERRED EMBODIMENTS

The reference point of directions referred in the following sections in detailed description of the preferred embodiment is a user wearing eyeglasses. For example, an inner lateral direction means a direction from two temples toward a bridge of the eyeglasses.

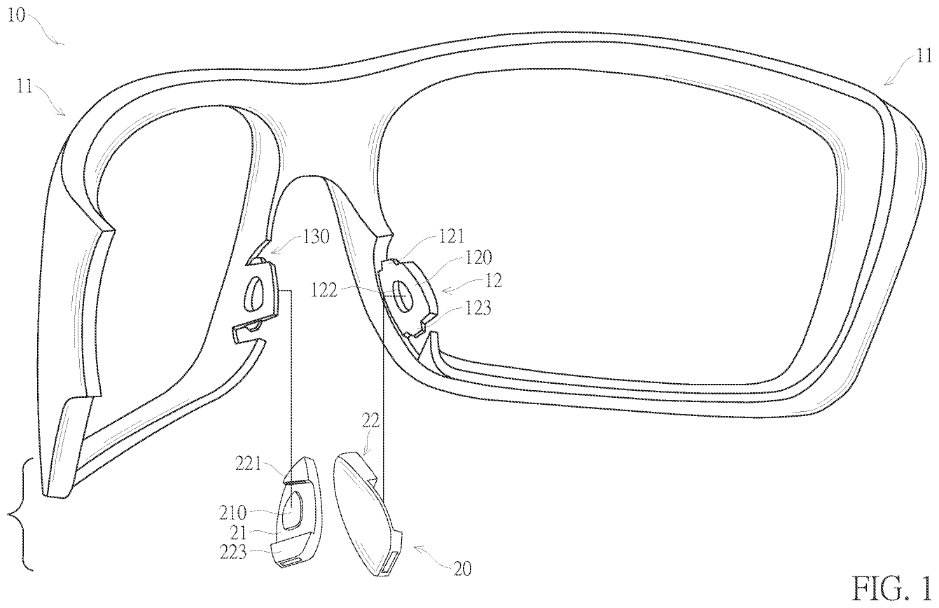

With reference to FIG. 1, an eyeglasses frame and nose pad assembly in accordance with the present invention has an eyeglasses frame 10 and two nose pads 20. The eyeglasses frame 10 includes two rims 11 and two combining portions 12. Each one of the combining portions 12 is formed on a lateral part of a respective one of the rims 11, and the two lateral parts of the two rims 11 are oriented toward each other.

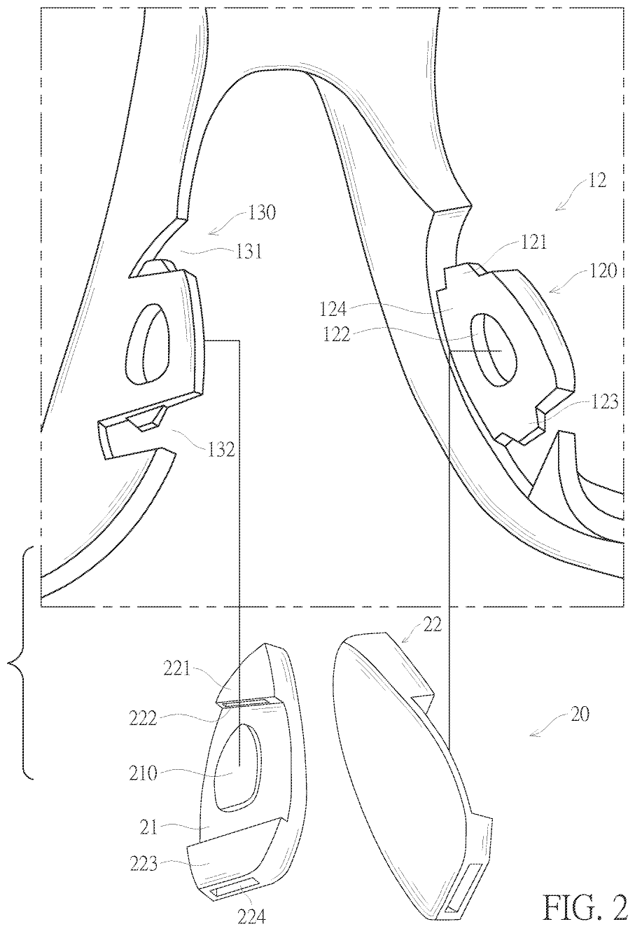

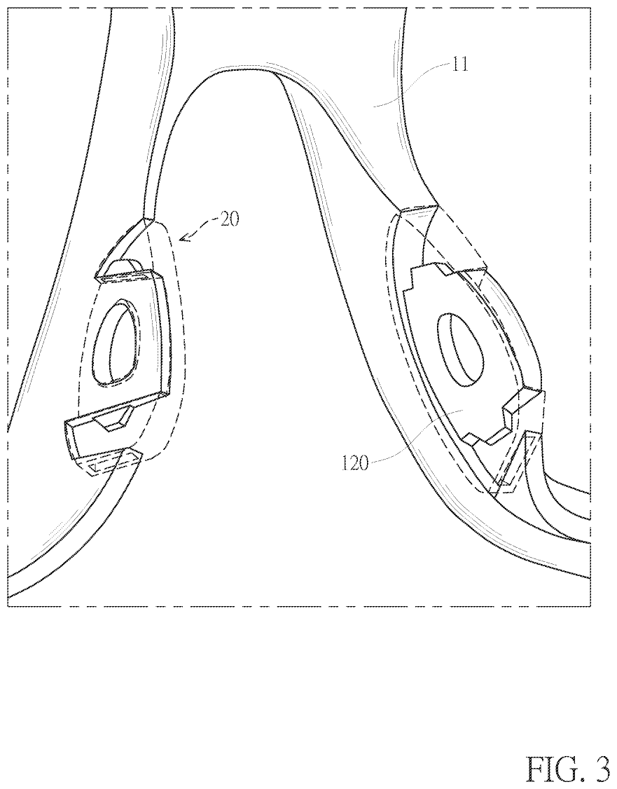

With reference to FIGS. 1 to 3, in a first embodiment of the eyeglasses frame and nose pad assembly, each one of the combining portions 12 has a main body 120 and two recesses 130. One of the recesses 130 is an upper recess 131 which is formed by a side of the main body 120 which is oriented upward, and another one of the recesses 130 is a lower recess 132 which is formed by a side of the main body 120 which is oriented downward. A first primary engaging portion 121 is formed on a side of the main body 120 which is oriented toward the upper recess 131, and a third primary engaging portion 123 is formed on a side of the main body 120 which is oriented toward the lower recess 132. In addition, a second primary engaging portion 122 is formed on an inner lateral surface of the main body 120 which faces to a nose of a user.

To be more precise, in this embodiment, the first primary engaging portion 121 of the main body 120 of each one of the combining portions 12 is an upward protruding structure which protrudes from a side surface of the main body 120 which faces upward, and the third primary engaging portion 123 is a downward protruding structure which protrudes from a side surface of the main body 120 which faces downward. In addition, the second primary engaging portion 122 is a recessed structure which is recessed along a thickness direction of the main body 120 from the inner lateral surface 124 of the main body 120, and the recessed structure may be a through hole or a blind hole. However, the structures of the first primary engaging portion 121, the second primary engaging portion 122, and the third primary engaging portion 123 are not limited by the aforementioned description; for example, the first primary engaging portion 121, the second primary engaging portion 122, and the third primary engaging portion may be altered as protruding structures or recessed structures due to demands of the user.

The two nose pads 20 are flexible and detachably mounted on the two combining portions 12 respectively. To be more precise, each one of the nose pads 20 has an abutting portion 21 and two protrusions 22, and the abutting portion 21 is connected to each one of the protrusions 22. One of the protrusions 22 is an upper protrusion 221 which is formed on an upper part of the abutting portion 21, and another one of the protrusions 22 is a lower protrusion 223 which is formed on a lower part of the abutting portion 21. The upper protrusion 221 is capable of engaging with the upper recess 131 of the corresponding combining portion 12, and the lower protrusion 223 is capable of engaging with the lower recess 132 of the corresponding combining portion 12.

In each one of the nose pads 20, a side surface of the upper protrusion 221 and a side surface of the lower protrusion 223 face to each other; a first secondary engaging portion 222 is formed on and recessed from the side surface of the upper protrusion 221, and a third secondary engaging portion 224 is formed on and recessed from the side surface of the lower protrusion 223. The first secondary engaging portion 222 is capable of detachably engaging with the first primary engaging portion 121 of the corresponding combining portion 12, and the third secondary engaging portion 224 is capable of detachably engaging with the third primary engaging portion 123 of the corresponding combining portion 12.

A second secondary engaging portion 210 is formed on and protrudes from the abutting portion 21 along a thickness direction of each one of the nose pads 20. The second secondary engaging portion 210 is capable of detachably engaging with the second primary engaging portion 122 of the corresponding combining portion 12, i.e., a direction of the second secondary engaging portion 210 protruding from the nose pad 20 is parallel to a direction of the nose pad 20 engaging with the corresponding combining portion 12. However, the structures of the first secondary engaging portion 222, the second secondary engaging portion 210, and the third secondary engaging portion 224 are not limited to the aforementioned description; for example, the first secondary engaging portion 222, the second secondary engaging portion 210, and the third secondary engaging portion 224 may be altered as protruding structures or recessed structures due to demands of the user.

To combine the nose pads 20 with the combining portions 12 of the eyeglasses frame 10, first let the inner lateral surface 124 of the main body 120 of each one of the combining portions 12 face to the abutting portion 21 of a corresponding one of the nose pads 20, and then engage the first secondary engaging portion 222 of the upper protrusion 221 with the first primary engaging portion 121 of the main body 120; meanwhile, press the upper protrusion 221 into the upper recess 131.

Next, press the second secondary engaging portion 210 of the abutting portion 21 into the second primary engaging portion 122, and thus the abutting portion 21 of the nose pad 20 extends on the inner lateral surface 124 of the main body 120.

Finally, slightly stretch the nose pad 20 to engage the third secondary engaging portion 224 of the lower protrusion 223 with the third primary engaging portion 123 of the main body 120, and then press the lower protrusion 223 into the lower recess 132 to complete combining the nose pad 20 with the combining portion 12 of the eyeglasses frame 10.

An order of steps of a combining process of the nose pads 20 with the combining portions 12 of eyeglasses frame 10 is not limited by the aforementioned description. Due to a flexibility of each one of the nose pads 20, a process of engaging the nose pad 20 with the eyeglasses frame 10 may start with engaging the first secondary engaging portion 222, the second secondary engaging portion 210, or the third secondary engaging portion 224. Whichever of the first secondary engaging portion 222, the second secondary engaging portion 210, or the third secondary engaging portion 224 is engaged first, the nose pad 20 still could be successfully combined with the combining portion 12 of the eyeglasses frame 10.

Via the first primary engaging portion 121 engaging with the first secondary engaging portion 222, the second primary engaging portion 122 engaging with the second secondary engaging portion 210, and the third primary engaging portion 123 engaging with the third secondary engaging portion 224, further with the upper recess 131 engaging with the upper protrusion 221, the lower recess 132 engaging with the lower protrusion 223, and the abutting portion 21 of the nose pad 20 extending on the inner lateral surface 124 of the main body 120, each one of the nose pads 20 can be firmly mounted on the corresponding combining portion 12 of the eyeglasses frame 10.

When each one of the two nose pads 20 is engaging with the corresponding combining portion 12, a surface of said nose pad 20 which would contact the nose of the user is level with a part of a corresponding one of the two rims 11 surrounding said nose pad 20.

To be more precise, each one of the two nose pads 20 has a contact surface which would contact the nose of the user, and the parts of the rims 11 which surround the nose pads 20 are level with the contact surfaces of the nose pads 20 respectively. Therefore, the contact surface of each one of the nose pads 20 and the part of the corresponding rim 11 which surrounds said nose pad 20 together form a smooth surface to reduce discomfort of the user, but it is not limited thereto; the nose pads 20 may protrude from the parts of the rims 11 which surround the nose pads 20 respectively. Furthermore, the nose pads 20 may have different thicknesses for users to select and thus help fit different types of noses.

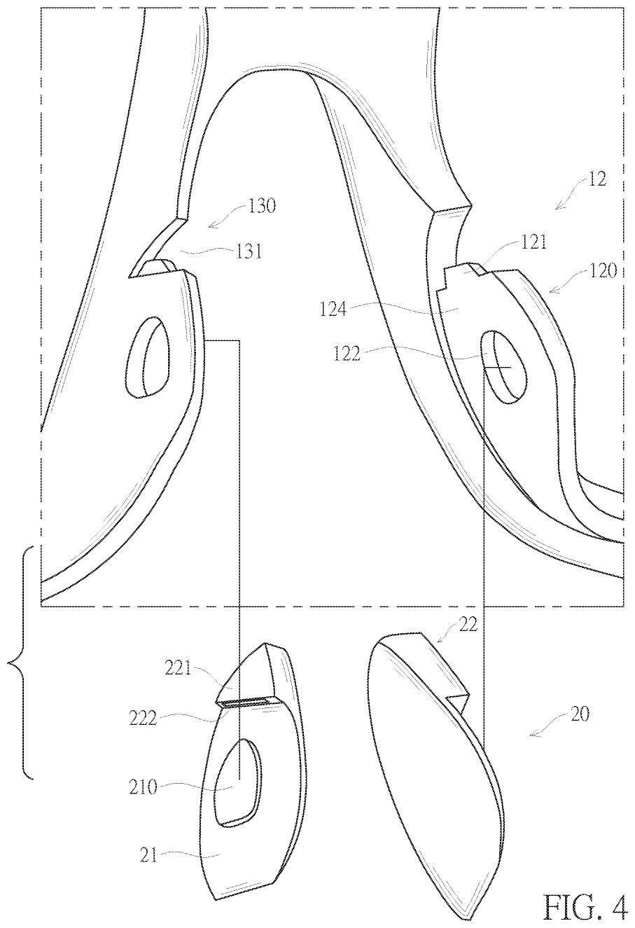

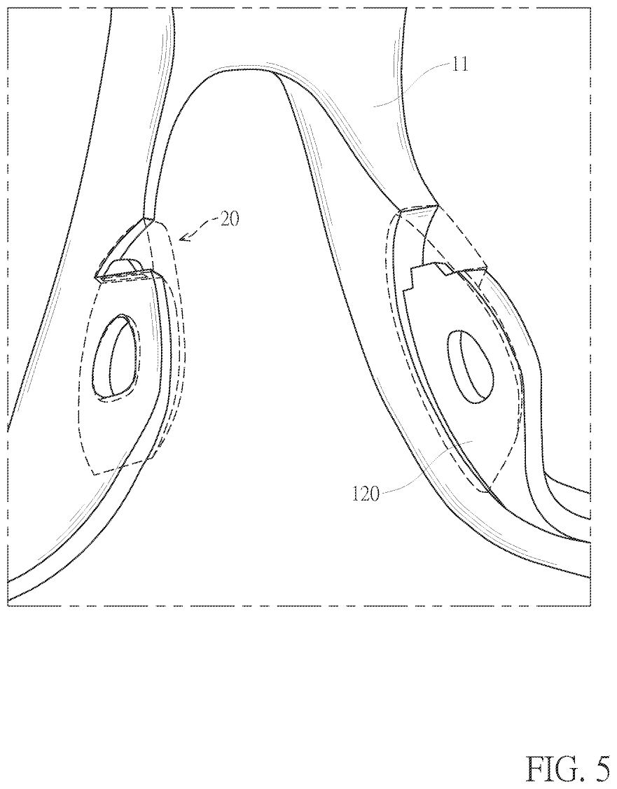

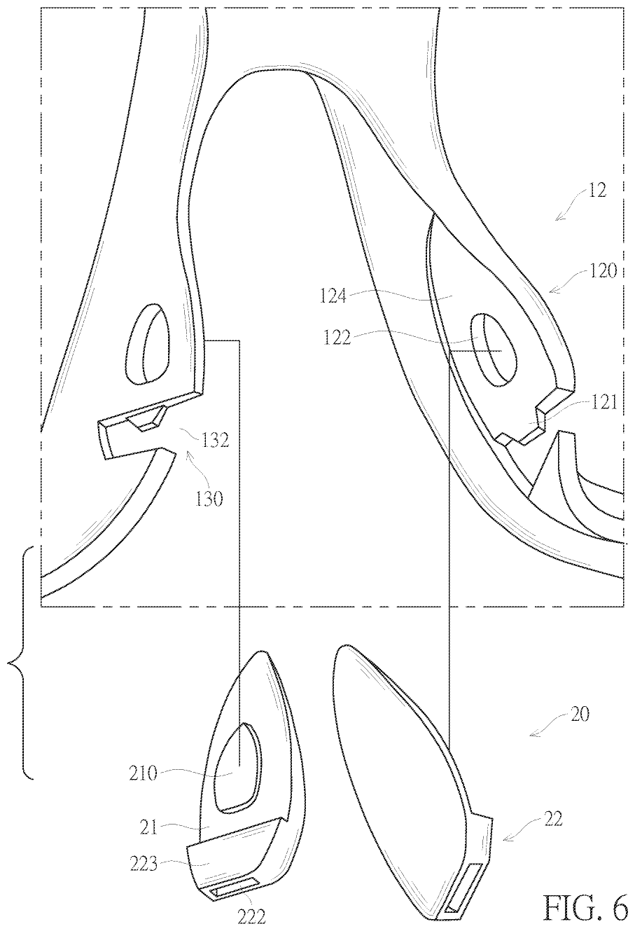

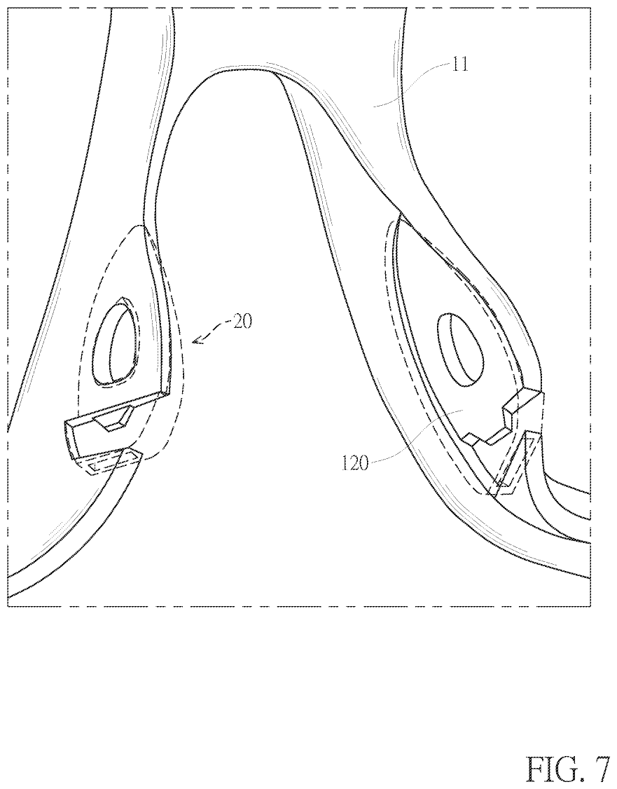

As shown in FIGS. 4 and 5, a second embodiment of the eyeglasses frame and nose pad assembly is similar to the first embodiment, but the second embodiment does not have the lower recess 132, the third primary engaging portion 123, the lower protrusion 223, and the third secondary engaging portion 224. As shown in FIGS. 6 and 7, a third embodiment of the eyeglasses frame and nose pad assembly is similar to the first embodiment, but the third embodiment does not have the upper recess 131 and the upper protrusion 221. In addition, the first primary engaging portion 121 protrudes downward and the first secondary engaging portion 222 is recessed from the side surface of the lower protrusion 223.

Combining processes of the nose pads 20 with the combining portions 12 in the second embodiment and the third embodiment may be simpler and faster than the combining process in the first embodiment.

In the second embodiment, first engage the first secondary engaging portion 222 and the upper protrusion 221 of each one of the nose pads 20 with the first primary engaging portion 121 and the upper recess 131 of the corresponding combining portion 12, and then press the second secondary engaging portion 210 into the second primary engaging portion 122 to complete combining the nose pads 20 with the combining portions 12.

Likely, in the third embodiment, first engage the first secondary engaging portion 222 and the lower protrusion 223 of each one of the nose pads 20 with the first primary engaging portion 121 and the lower recess 132 of the corresponding combining portion 12, and then press the second secondary engaging portion 210 into the second primary engaging portion 122 to complete combining the nose pads 20 with the combining portions 12.

In each one of the second embodiment and the third embodiment, thickness of each one of the two nose pads 20 gradually decreases from an end which is adjacent to the protrusion 22 to another end. To be more precise, the thickness of each one of the nose pads 20 in the second embodiment and the third embodiment gradually decreases from the end with the first secondary engaging portion 222 formed on the upper part to the opposite end. The end of each one of the nose pads 20 without the protrusion 22 may reduce weight via reducing thickness, thereby preventing the nose pad 20 from detaching from the corresponding combining portion 12 due to gravity.

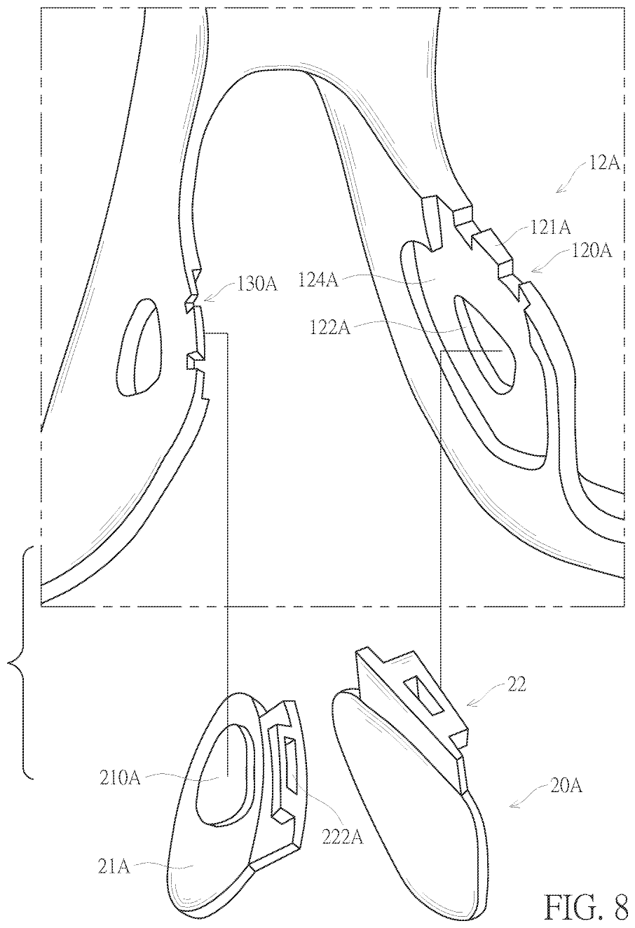

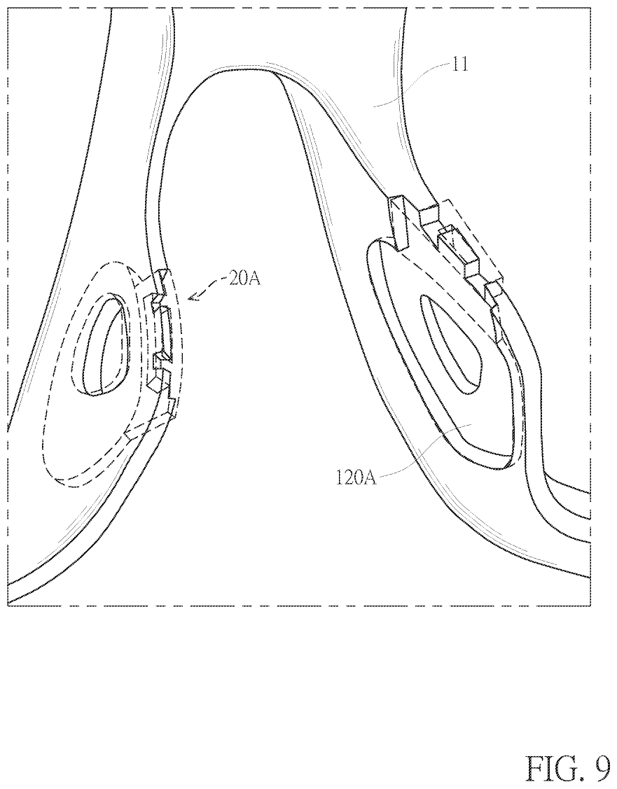

Next, with reference to FIGS. 8 to 9, in a fourth embodiment of the eyeglasses frame and nose pad assembly, the combining portions 12A and the nose pads 20A are similar to the second embodiment and the third embodiment, but the recess 130A of each one of the combining portions 12A is formed on a side of the main body 120A which is oriented toward a face of the user. Correspondingly, the protrusion 22A of each one of the nose pads 20A is formed on a lateral side of the abutting portion 21A.

To be more precise, in the fourth embodiment, each one of the two combining portions 12A is formed on a part of the corresponding rim 11A which would contact the nose of the user, and the combining portion 12A is recessed from a surface of said part of the corresponding rim 11A which would contact the nose of the user. Each one of the combining portions 12A has one said main body 120A and one said recess 130A, and the recess 130A is formed on the side of the main body 120A which is oriented toward the face of the user. Furthermore, one said first primary engaging portion 121A is formed on a side wall of the main body 120A which faces toward the recess 130A, and one said second primary engaging portion 122A is recessed from the inner lateral surface 124A of the main body 120A which faces toward the nose of the user.

In the fourth embodiment, each one of the nose pads 20A has one said abutting portion 21A and one said protrusion 22A which are connected to each other. The protrusion 22A is formed on a side of the abutting portion 21A, and a configuration of the protrusion 22A corresponds to a configuration of the recess 130A of the corresponding combining portion 12A, and thus the protrusion 22A is capable of engaging with the recess 130A of the corresponding combining portion 12A.

One said first secondary engaging portion 222A is formed on the protrusion 22A of each one of the nose pads 20A, and the first secondary engaging portion 222A is capable of detachably engaging with the first primary engaging portion 121A. One said second secondary engaging portion 210A protrudes from the abutting portion 21A of each one of the nose pads 20A along the thickness direction of the corresponding nose pad 20A. The second secondary engaging portion 210A is capable of detachably engaging with the second primary engaging portion 122A.

In the fourth embodiment, when the nose pads 20A are mounted on the combining portions 12A, the surfaces of the nose pad 20A which would contact the nose of the user are level with the parts surrounding the nose pads 20A of the rims 11A respectively, and together form a smooth surface. In addition, in each one of the nose pads 20A, a side surface of the protrusion 22A is away from the abutting portion 21A, and edges of the side surface are level with parts of the corresponding rim 11A which surround the side surface to form a smooth border of the side surface, but it is not limited thereto.

In all of the embodiments, the second primary engaging portions 122/122A and the corresponding second secondary engaging portions 210/210A may be in any shape; for example, the second primary engaging portions 122/122A and the corresponding second secondary engaging portions 210/210A may be round, and thereby the second secondary engaging portions 210/210A are capable of being pressed into the second primary engaging portions 122/122A without aligning positions or angles, and thus the combining process becomes more convenient.

On the other hand, each one of the second primary engaging portions 122/122A and each one of the corresponding second secondary engaging portions 210/210A may be designed in a non-circular shape, such as an oval, a rectangle, or a star, etc., to offer a foolproof effect, and a stability of combining of the nose pads 20/20A with the combining portions 12/12A increases in another aspect. Besides, various designs of the second primary engaging portions 122/122A and the second secondary engaging portions 210/210A bring variations to appearances of the eyeglasses frame and nose pad assemblies.

In summary, the eyeglasses frame and nose pad assembly in this disclosure has advantages as follows:

(1) By omitting pad arms, a connection between the nose pads 20/20a and the eyeglasses frame 10 gets a better strength to resist collision, thereby preventing the eyeglasses frame and nose pad assembly from deformation and breaking, and further reducing a manufacturing cost.

(2) By combining the two nose pads 20/20A which are flexible with the two combining portions 12/12A respectively via engaging, comfort of wearing the eyeglasses frame and nose pad assembly increases, and provides a strong slip-resistance and a support performance to prevent the eyeglasses frame and nose pad assembly from slipping from the nose of the user.

(3) A multi-fixing effect is achieved via engaging along varied directions between the nose pads 20/20A and the combining portions 12/12A; meanwhile, a fixing effect is enhanced via the main body 120/120A extending on the abutting portion 21/21A and the recess 130/130A engaging with the protrusion 22/22A, thereby preventing the nose pads 20/20A from detaching.

(4) By engaging the nose pads 20/20A with the combining portions 12/12A, to combine the nose pads 20/20A with the combining portions 12/12A and to detach the nose pads 20/20A from the combining portions 12/12A are convenient to achieve. Furthermore, an efficiency of manufacturing the eyeglasses frame and nose pad assembly increases as well as an assembling time and a labor reduce. The user can also clean or replace the nose pads 20/20A with ease.

(5) The nose pads 20/20A may have different thicknesses for the user to select, fitting a wearing angle according to preferences of the user.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An eyeglasses frame and nose pad assembly comprising:
an eyeglasses frame having:
two rims; and
two combining portions, and each one of the two combining portions formed on a lateral part of a respective one of the two rims, and the two lateral parts of the two rims oriented toward each other; each one of the two combining portions including:
at least one recess; and
a main body having:
a first primary engaging portion formed on a side, which is oriented toward the at least one recess, of the main body; and
a second primary engaging portion formed on an inner lateral surface of the main body which faces to a nose of a user; the first primary engaging portion and the second primary engaging portion being formed in different directions; and
two nose pads detachably mounted on the two combining portions respectively, and each one of the two nose pads being flexible and having:
at least one protrusion engaging with the at least one recess of a corresponding one of the two combining portions;
a first secondary engaging portion formed on the at least one protrusion and detachably engaging with the first primary engaging portion of the main body of the corresponding combining portion;
an abutting portion connected to the at least one protrusion; and
a second secondary engaging portion formed on the abutting portion and detachably engaging with the second primary engaging portion of the main body of the corresponding combining portion; the first secondary engaging portion and the second secondary engaging portion being formed in different directions.

2. The eyeglasses frame and nose pad assembly as claimed in claim 1, wherein:
a number of the at least one recess of each one of the two combining portions is one, and the recess is formed by another side, which is oriented upward, of the main body;
a number of the at least one protrusion of each one of the two nose pads is one, and the protrusion is formed at an upper part of the abutting portion.

3. The eyeglasses frame and nose pad assembly as claimed in claim 1, wherein:
a number of the at least one recess of each one of the two combining portions is one, and the recess is formed by another side, which is oriented downward, of the main body; and
a number of the at least one protrusion of each one of the two nose pads is one, and the protrusion is formed at a lower part of the abutting portion.

4. The eyeglasses frame and nose pad assembly as claimed in claim 1, wherein:
a number of the at least one recess of each one of the two combining portions is one, and the recess is formed on another side, which is oriented toward a face of the user, of the main body; and
a number of the at least one protrusion of each one of the two nose pads is one, and the protrusion is formed on a lateral side of the abutting portion.

5. The eyeglasses frame and nose pad assembly as claimed in claim 1, wherein:
the main body of each one of the two combining portions has a third primary engaging portion; the first primary engaging portion is formed on a side, which is oriented upward, of the main body, and the third primary engaging portion is formed on another side, which is oriented downward, of the main body;
a number of the at least one recess of each one of the two combining portions is two; one of the two recesses is formed by the side of the main body which is oriented upward, and another one of the two recesses is formed by the side of the main body which is oriented downward;
each one of the two nose pads has a third secondary engaging portion detachably engaging with the third primary engaging portion of the main body of the corresponding combining portion; and
a number of the at least one protrusion of each one of the two nose pads is two, and the two protrusions are formed on an upper part and a lower part of the abutting portion respectively; each one of the two protrusions has a side surface and the two side surfaces of the two protrusions face to each other, and the first secondary engaging portion and the third secondary engaging portion are formed on the side surfaces of the two protrusions respectively.

6. The eyeglasses frame and nose pad assembly as claimed in claim 1, wherein the first primary engaging portion of the main body of each one of the two combining portions is a protruding structure.

7. The eyeglasses frame and nose pad assembly as claimed in claim 5, wherein the first primary engaging portion of the main body of each one of the two combining portions is a protruding structure.

8. The eyeglasses frame and nose pad assembly as claimed in claim 1, wherein the second primary engaging portion of the inner lateral surface of the main body of each one of the two combining portions is a recessed structure.

9. The eyeglasses frame and nose pad assembly as claimed in claim 7, wherein the second primary engaging portion of the inner lateral surface of the main body of each one of the two combining portions is a recessed structure.

10. The eyeglasses frame and nose pad assembly as claimed in claim 1, wherein the second primary engaging portion of the inner lateral surface of the main body of each one of the two combining portions is non-circular.

11. The eyeglasses frame and nose pad assembly as claimed in claim 9, wherein the second primary engaging portion of the inner lateral surface of the main body of each one of the two combining portions is non-circular.

12. The eyeglasses frame and nose pad assembly as claimed in claim 1, wherein:
each one of the two nose pads has a contact surface configured to contact the nose of the user; and
when each one of the two nose pads is engaging with a corresponding one of the two combining portions, the contact surface of said nose pad is level with a part of a corresponding one of the two rims surrounding said nose pad.

13. The eyeglasses frame and nose pad assembly as claimed in claim 11, wherein:
each one of the two nose pads has a contact surface configured to contact the nose of the user; and
when each one of the two nose pads is engaging with a corresponding one of the two combining portions, the contact surface of said nose pad is level with a part of a corresponding one of the two rims surrounding said nose pad.

14. The eyeglasses frame and nose pad assembly as claimed in claim 2, wherein a thickness of each one of the two nose pads gradually decreases from an end which is adjacent to the protrusion to another end.

15. The eyeglasses frame and nose pad assembly as claimed in claim 3, wherein a thickness of each one of the two nose pads gradually decreases from an end which is adjacent to the protrusion to another end.
